(19) United States
(12) Patent Application Publication
(10) Pub. No.: US 2020/0386624 A1
(43) Pub. Date: Dec. 10, 2020

(54) SENSOR

(71) Applicant: SUZHOU EV-BLUE ELECTRONIC TECHNOLOGY CO. LTD, Jiangsu (CN)

(72) Inventors: Zhiyong Hu, Jiangsu (CN); Bin Hui, Jiangsu (CN)

(21) Appl. No.: 16/750,916

(22) Filed: Jan. 23, 2020

Related U.S. Application Data
(63) Continuation of application No. PCT/CN2019/082478, filed on Apr. 12, 2019.

(30) Foreign Application Priority Data
Apr. 18, 2018 (CN) 201820553431.4

(51) Int. Cl. G01K 1/12; G01K 1/02; G01K 1/16

(52) U.S. Cl. CPC G01K 1/12; G01K 1/16; G01K 1/024

(57) ABSTRACT

Disclosed is a sensor, comprising: a housing; a detecting element provided inside the housing; a first cylinder provided inside the housing and sleeved outside the detecting element, the first cylinder having an amount of elastic deformation in a direction intersecting a surface around the detecting element; a particle filler, for filling an inner cavity of the housing. When external environment produces mechanical shock to the sensor or the sensor produces mechanical vibration, the limiting action of the first cylinder and the particle filler enables the detecting element to only have very little vibration displacement or even no vibration displacement with respect to the housing. The external mechanical shock can be partially or completely absorbed by the first cylinder and the particle filler, so as to reduce vibration displacement of the detecting element caused by the shock.

### CROSS REFERENCE TO RELATED APPLICATIONS

This application is a continuation of International Application No. PCT/CN2019/082478, filed on Apr. 12, 2019, which is based upon and claims priority to Chinese Patent Application No. 2018205534314, filed on Apr. 18, 2018, the entire contents of which are incorporated herein by reference.

### TECHNICAL FIELD

The present application belongs to the technical field of sensors, and particularly relates to a sensor.

### BACKGROUND

As the air pollution is becoming increasingly serious, various counties in the world put increasingly strict control on the polluting sources, and as automobiles are a major discharge source of polluting gas, every country is continuously enacting more strict tail-gas discharge standards. Wherein, along with the implement of National-5 Discharge Regulation and the incoming formal implement of National-6 Discharge Regulation, various systems of an automobile need to be upgraded accordingly. As for the turbocharging system, the exhaust gas recirculation system and various post-emission treatment systems of an automobile, the sensor(s) thereof is an important and indispensable part.

For example, a sensor system in prior art comprises a mineral insulation cable, a detecting element, a wiring harness component and a connector; one end of the mineral insulation cable is welded to the detecting element, and the other end thereof is connected to the wiring harness component via the connector; the electrical wires in the wiring harness component are connected to a controller, for transmitting signal detected by the detecting element to the controller via the insulation cable and the electrical wires in the wiring harness component. A bushing is sleeved outside the detecting element and welded to the mineral insulation cable, with filler material such as magnesium oxide provided inside the bushing.

When this sensor system is applied in an automobile, because of nonuniform filling of the filler material such as magnesium oxide, the buffering effect towards mechanical vibration and mechanical shock coming from external environment is not satisfactory, the detecting element easily produces vibration in the bushing, which causes the welded portion between a pin of the detecting element and the cable to break off or split, and in turn causes a function failure of the sensor.

### SUMMARY OF THE APPLICATION

Thus, a technical problem to be solved by the present application is that the existing sensor system has poor capability of vibration reducing.

To this end, the present application provides a sensor, comprising

a housing;
a detecting element, provided inside the housing;
a first cylinder, provided inside the housing and sleeved outside the detecting element, the first cylinder having an amount of elastic deformation in a direction intersecting a surface around the detecting element;
a particle filler, for filling an inner cavity of the housing.

Optionally, in the afore-mentioned sensor, the first cylinder has at least one through-hole provided thereon.

Optionally, in the afore-mentioned sensor, the first cylinder has a recessed region in a radially inward direction; the recessed region is sleeved on the detecting element, and the through-hole is formed in the recessed region.

Optionally, in the afore-mentioned sensor, the recessed region comprises, along an axial direction of the first cylinder, a straight first segment and a first flared segment flaring outward from one open end of the first segment, the first segment fitting closely on the detecting element.

Optionally, in the afore-mentioned sensor, the through-hole has a notch shape, with an open end of the notch shape situated away from the first flared segment.

Optionally, in the afore-mentioned sensor, the recessed region also comprises a second flared segment flaring outward from the other open end of the first segment, so that the recessed region has a crown spring structure.

Optionally, in the afore-mentioned sensor, the recessed region also comprises a second flared segment flaring outward from the other open end of the first segment; the first flared segment has a curved structure protruding outward, with an outer wall of the curved structure fitting closely on an inner wall of the housing.

Optionally, in the afore-mentioned sensor, at least two through-holes are provided, each of the through-holes is arranged to extend in an axial direction of the first cylinder, and all the through-holes are distributed in a circumferential direction of the recessed region.

Optionally, in the afore-mentioned sensor, a portion of the housing corresponding to the first segment is a contraction section, with an inner wall of the contraction section fitting closely on an outer wall of the first segment.

Optionally, in the afore-mentioned sensor, the recessed region is made of elastic material.

Optionally, in the afore-mentioned sensor, the sensor also comprises a transmitting cable and a wiring harness component; one end of the transmitting cable is arranged to extend sealedly into the housing and be connected to the detecting element, the other end of the transmitting cable is connected to the wiring harness component; the wiring harness component is connected to an external control circuit, for transmitting signal detected by the detecting element via the transmitting cable to the control circuit.

Optionally, in the afore-mentioned sensor, one end of the housing away from the detecting element is sealedly sleeved on the transmitting cable, and the other end of the housing is arranged to sealedly enclose the detecting element and the first cylinder.

Optionally, in the afore-mentioned sensor, the end of the housing sleeved on the transmitting cable has a first contraction opening, and the other end of the housing opposite to the first contraction opening has a contraction segment, the end part of the contraction segment is in the form of a closed end, with a gap preserved between an inner wall of the closed end and the detecting element.

Optionally, in the afore-mentioned sensor, the wiring harness component comprises

a second cylinder;
an electric line, one end of the electric line is arranged to sealedly pass through one axial side wall of the second cylinder and be connected to the control circuit, and the other end of the electric line is arranged to sealedly pass through the other axial side wall of the second cylinder and be connected to the transmitting cable;
a third cylinder, one end of which is sealedly sleeved, through an elastic sealing element, on the second cylinder or on a portion of the electric line outside the second cylinder, the other end of which is arranged to extend in a direction towards the transmitting cable and be sealedly fixed on an outer wall of the transmitting cable, so as to enclose a connection end of the transmitting cable connecting to the electric line inside the third cylinder.

Optionally, in the afore-mentioned sensor, an annular groove is provided on a circumferential outer wall of the second cylinder; the sealing element is nested in the annular groove, and the third cylinder is closely pressed on an outer wall of the sealing element.

Optionally, in the afore-mentioned sensor, the outer wall of the sealing element has at least one annular protrusion, and the third cylinder is closely pressed on the annular protrusion.

Optionally, in the afore-mentioned sensor, a wall of the third cylinder has a first annular riveting part recessed inward; the first annular riveting part is closely inserted in a groove between two neighboring annular protrusions.

Optionally, in the afore-mentioned sensor, at least one annular groove is provided, the sealing element is a sealing ring, and the sealing ring is correspondingly nested in the annular groove.

Optionally, in the afore-mentioned sensor, one end of the second cylinder away from the transmitting cable is arranged to extend out of the third cylinder and be sealedly sleeved on the electric line.

Optionally, in the afore-mentioned sensor, when one end of the third cylinder is sealedly sleeved, through the elastic sealing element, on a portion of the electric line outside the second cylinder, the sealing element is sealedly sleeved on the electric line, with one end thereof facing the second cylinder abuts against an end face of the second cylinder; one end of the third cylinder away from the transmitting cable is closely sleeved on the sealing element.

Optionally, in the afore-mentioned sensor, the end of the third cylinder away from the transmitting cable has a second contraction end contracted radially inward; both ends of the sealing element abut, respectively, against an end face of the second cylinder and against an inner wall of the second contraction end, so as to accommodate the sealing element and the second cylinder in an inner cavity of the third cylinder.

Optionally, in the afore-mentioned sensor, a circumferential outer wall of the sealing element has at least one annular protrusion, a wall of the third cylinder has a first annular riveting part recessed inward; the first annular riveting part is closely inserted in a groove between two neighboring annular protrusions.

Optionally, in the afore-mentioned sensor, the detecting element is a temperature sensing element; the housing, the first cylinder and the particle filler are made of heat conductive material.

The technical solutions provided by the present application has the following advantages:

1. The sensor provided by the present application comprises a housing, a detecting element, a first cylinder and a particle filler. The first cylinder is provided inside the housing and sleeved outside the detecting element, the first cylinder has an amount of elastic deformation in a direction intersecting a surface around the detecting element, and the particle filler fills an inner cavity of the housing.

When external environment produces mechanical shock to the sensor or the sensor produces mechanical vibration, the external mechanical shock can be partially or completely absorbed by the first cylinder with an amount of elastic deformation and the particle filler, so as to reduce vibration displacement of the detecting element caused by the shock; meanwhile, the first cylinder and the particle filler have a limiting action on the detecting element such that the vibration displacement amount of the detecting element is buffered and absorbed, thereby enabling the detecting element to only have very little vibration displacement or even no vibration displacement relative to the housing. Because the detecting element has very little vibration displacement or even no vibration displacement relative to the housing, the connection portion of a pin of the detecting element would not receive too much force to cause breaking off or splitting, so that a function failure of the sensor due to mechanical vibration or external mechanical shock is prevented, and the reliability of the detecting element and the sensor is ensured.

As the detecting element has a small volume and a light mass, during installation by welding, the detecting element may deviate towards one lateral side of the housing or even come into contact with an inner wall of the housing. The first cylinder can guide the detecting element during installation and correct any offset angle of the detecting element, thereby holding the detecting element in a central position in a radial direction of the housing, so that the detecting element is prevented from strong impact with the inner wall of the housing during operation due to offset shifting which would ultimately cause splitting of a pin of the detecting element.

2. In the sensor provided by the present application, the first cylinder has a recessed region, and the recessed region is provided with a through-hole, which reduces the overall rigidity of the first cylinder, makes the first cylinder have better capability of elastic deformation, and thus makes the first cylinder have stronger capability of vibration reducing and buffering.
3. In the sensor provided by the present application, a portion of the housing corresponding to the first segment is a contraction section, with an inner wall of the contraction section fitting closely on an outer wall of the first segment. The arrangement of the contraction section reduces a straight-line distance from the housing to the detecting element, so that the heat-conducting distance between the housing and the detecting element is reduced, and thus the heat-response time is shortened.
4. In the sensor provided by the present application, the wiring harness component comprises a second cylinder, an electric line, a third cylinder and a sealing element. The second cylinder is formed to encapsulate an end part of the electric line, an annular groove is provided on an outer wall of the second cylinder, and the sealing element is provided in the annular groove; one end of the third cylinder is sealedly sleeved on the sealing element outside the second cylinder, and the other end of the third cylinder is sealedly fixed on an outer wall of the transmitting cable, so that the third cylinder completely encloses a connection end of the transmitting cable connecting to the electric line.

The sealing element is closely compressed between the second cylinder and the third cylinder, so as to be able to form an effective sealing and prevent external substance such as liquid or gas from entering the third cylinder to cause a function failure of the sensor.

5. In the sensor provided by the present application, the outer wall of the sealing element has an annular protrusion, and correspondingly the third cylinder has a first annular riveting part, the first annular riveting part is closely pressed on the annular protrusion, so as to further strengthen its hermetic seal and increase the reliability of the sensor.
6. In the sensor provided by the present application, the detecting element is a temperature sensing element; the housing, the first cylinder and the particle filler are made of heat conductive material. The first cylinder and the particle filler cooperate together to conduct heat, with a higher heat conducting efficiency, so that the temperature-detecting response time of the sensor is shortened and the temperature detection can be performed more quickly and accurately.

### BRIEF DESCRIPTION OF THE DRAWINGS

In order to more clearly describe the technical solutions in the specific embodiments of the present application or in the prior art, hereinafter, the appended drawings used for describing the specific embodiments or the prior art will be briefly introduced. Apparently, the appended drawings described below are only some embodiments of the present application, and for a person with ordinary skill in the art, without expenditure of creative labor, other drawings can be derived on the basis of these appended drawings.

FIG. 1 is a sectional view of a sensor provided in Embodiment 1 of the present application;

FIG. 2 is a structural schematic view of the first cylinder of the sensor in FIG. 1;

FIG. 3 is a structural schematic view of the connector of the sensor in FIG. 1;

FIG. 4 is a structural schematic view of the second cylinder of the sensor in FIG. 1;

FIG. 5 is a structural schematic view of the sealing element of the sensor in FIG. 1;

FIG. 6 is a structural schematic view of a sensor provided in Embodiment 2 of the present application;

FIG. 7 is a sectional view of the sensor provided in FIG. 6;

FIG. 8 is a sectional view of a sensor provided in Embodiment 3 of the present application;

FIG. 9 is a structural schematic view of the housing of the sensor in FIG. 8;

FIG. 10 is a structural schematic view of the sensor in FIG. 8;

FIG. 11 is a structural schematic view of a sensor provided in Embodiment 8 of the present application;

FIG. 12 is an exploded view of a partial structure of the sensor in FIG. 11;

FIG. 13 is a longitudinal sectional view of the sensor in FIG. 12;

FIG. 14 is a cooperation schematic view of the connector, the electric line and the protective sleeve of the sensor in FIG. 12;

FIG. 15 is a cooperation structure of the transmitting cable, the connector and the electric line of the sensor in FIG. 11;

FIG. 16 is a schematic view of the sensor in FIG. 11 after removing the flange and the screw nut;

FIG. 17 is a structural schematic view of a sensor provided in Embodiment 9 of the present application;

FIG. 18 is a schematic view of the sensor in FIG. 11 after removing the flange, the screw nut and the control circuit;

FIG. 19 is an exploded view of the sensor in FIG. 18;

FIG. 20 is a structural schematic view of the sealing element of the sensor in FIG. 17;

FIG. 21 is a longitudinal sectional view of the sensor in FIG. 18;

FIG. 22 is an exploded view of the housing, the first cylinder, the detecting element and the transmitting cable of a sensor provided in Embodiment 10 of the present application;

FIG. 23 is a longitudinal sectional view of the housing, the first cylinder, the detecting element and the transmitting cable, after cooperating together, of a sensor provided in Embodiment 10 of the present application;

FIG. 24 is a cooperation schematic view of the first cylinder and the detecting element of the sensor in FIG. 22.

### REFERENCE SIGNS

1—housing; 11—mounting step; 12—cap; 13—sealing chamber; 14—contraction section; 15—sealed section; 16—first contraction opening;
2—detecting element;
3—first cylinder; 31—through-hole; 32—recessed region; 321—first segment; 322—first flared segment; 323—second flared segment; 33—buffering hole;
5—transmitting cable; 51—metal sheath; 52—conductive line;
61—second cylinder; 611—annular groove; 612—open hole; 613—outer extension end; 614—curved groove; 62—electric line; 63—third cylinder; 631—first annular riveting part; 632—first contraction end; 633—second contraction end; 64—sealing element; 641—annular protrusion; 65—protective sleeve;
7—connector; 71—curved part; 72—curved cavity; 73—foldable edge;
8—flange;
9—screw nut.

### DETAILED DESCRIPTION OF EMBODIMENTS

A clear and complete description of the technical solution of the present application is given below, in conjunction with the appended drawings. Apparently, the described embodiments are part of, but not all of, the embodiments of the present application. All the other embodiments, obtained by a person with ordinary skill in the art on the basis of the embodiments in the present application without expenditure of creative labor, belong to the protection scope of the present application.

In the description of the present application, it should be noted that, terms such as “center”, “above”, “below”, “left”, “right”, “vertical”, “horizontal”, “inside”, “outside” refer to the orientation or positional relationship based on the illustration of the appended drawings, and are only for the purpose of facilitating and simplifying the description of the present application, rather than indicating or implying that the apparatus or component referred to must have a particular orientation or must be configured or operated in a particular orientation, therefore should not be construed as a limitation towards the present application. In addition, terms such as “first”, “second”, “third” are merely for the purpose of description and should not be construed as an indication or implication of relative importance thereof.

In the description of the present application, it should be noted that, unless specifically defined or restricted otherwise, terms such as “mount”, “interconnect”, “connect” should be broadly construed, for example, it may be a fixed connection, a detachable connection or an integral connection; it may be a mechanical connection or an electrical connection; it may be either a direct connection or an indirect connection through an intermediate medium, or it may be an internal communication between two units. For a person skilled in the art, the specific meaning of the above terms in the present application may be understood according to specific situations thereof.

In addition, the technical features involved in different embodiments of the present application described below may be combined with one another as long as they do not conflict with one another.

### Embodiment 1

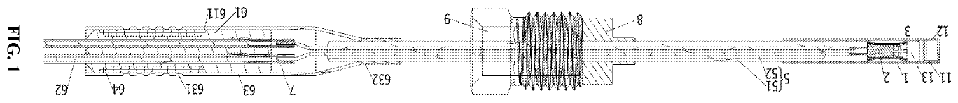

This embodiment provides a sensor, as shown in FIG. 1, the sensor comprises a housing 1, a cap 12, a detecting element 2, a first cylinder 3, a particle filler (not shown), a transmitting cable 5, a connector 7, a wiring harness component, a flange 8 and a screw nut 9.

Wherein, the transmitting cable 5 is preferably a mineral insulation cable and comprises a conductive line 52, a metal sheath 51 sleeved outside the conductive line 52, and inorganic insulation material or an inorganic insulation material layer filled inside the metal sheath 51 and surrounding the conductive line 52. The transmitting cable 5 has good high-temperature resistance and is able to transmit signal in a high-temperature environment. There are preferably two conductive lines 52.

The detecting element 2 is preferably a temperature sensing element, and two pins of the temperature sensing element are fixedly connected by welding to two conductive lines 52 at one end of the transmitting cable 5, and the welding is preferably laser welding.

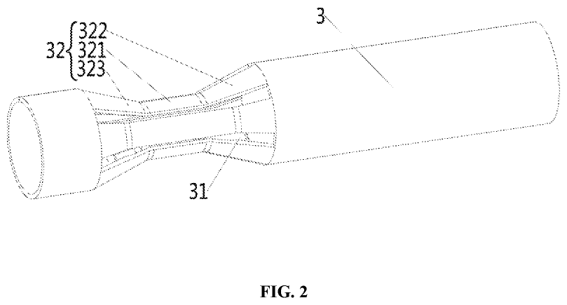

As shown in FIG. 1 and FIG. 2, the first cylinder 3 is preferably made of heat conductive metal material having elasticity, the first cylinder 3 is recessed in a radially inward direction to form a recessed region 32, and the recessed region 32 has an annular sleeve structure around the circumferential direction of the first cylinder 3. The recessed region 32 comprises a first segment 321, a first flared segment 322 and a second flared segment 323 that are integrally formed in one piece, the straight first segment 321 extends along an axial direction of the first cylinder 3, and the first segment 321 also has an annular sleeve structure on the whole; both open ends of the first segment 321 flare outward along an axial direction to form the first flared segment 322 and the second flared segment 323, respectively, the first flared segment 322 and the second flared segment 323 are mutually symmetrical flared structures, so that the recessed region 32 has an overall crown spring structure with an amount of elastic deformation in its radial direction.

The recessed region 32 is also provided with through-holes 31 extending in an axial direction of the first cylinder 3, for example, six through-holes 31 are provided in the recessed region 32, and the through-holes 31 are evenly distributed in the recessed region 32 around a circumferential direction of the first cylinder 3. The through-holes 31 reduce the overall rigidity of the first cylinder 3, make the first cylinder 3 have better capability of elastic deformation, and thus make the first cylinder 3 have stronger capability of vibration reducing and buffering.

The first cylinder 3 is sleeved outside the temperature sensing element and is fixedly connected to the transmitting cable 5. One open end of the first cylinder 3 is sleeved on an outer wall of the metal sheath 51 of the transmitting cable 5, and this end of the first cylinder 3 is fixed to the metal sheath 51 by circumference welding; the position of the temperature sensing element corresponds to the recessed region 32 on the first cylinder 3 and is right facing the first segment 321, an inner wall of the first segment 321 is adjacent to and fitting closely on an outer surface of the temperature sensing element, with a desired mounting gap reserved.

As shown in FIG. 1, the housing 1 is preferably a cylinder structure made of heat conductive metal material and is sleeved closely on an outer wall of the first cylinder 3; an end part at one end of the housing 1 extending outward has a mounting step 11 recessed in a radially inward direction, and an opening at the other end of the housing 1 extending outward is sleeved on the outer wall of the metal sheath 51 and is sealedly connected to the outer wall of the metal sheath 51 by circumference welding; an inner wall of the housing 1 is in close contact with the outer wall of the first cylinder 3.

The cap 12 is preferably a cylinder structure made of heat conductive metal material with a closed-end part at one end and an open-end part at the other end, the open-end part of the cap 12 is sleeved on the mounting step 11 of the housing 1, and the cap 12 is sealedly connected to the housing 1 by circumference welding, so that the cap 12, the housing 1 and the transmitting cable 5 together enclose a sealing chamber 13, with the temperature sensing element and the first cylinder 3 situated within the sealing chamber 13, thereby preventing the temperature sensing element from being damaged by external harmful environment.

The particle filler is preferably magnesium oxide powder, and is evenly filled in the sealing chamber 13 and distributed around the temperature sensing element, inside and outside the first cylinder 3.

When external environment produces mechanical shock to the sensor or the sensor produces mechanical vibration, the external mechanical shock can be partially or completely absorbed by the first cylinder 3 with elasticity and the particle filler, so as to reduce vibration displacement of the detecting element caused by the shock; meanwhile, the recessed region 32 and the particle filler together has a limiting action on the temperature sensing element such that the vibration displacement amount of the temperature sensing element is buffered and absorbed, thereby enabling the temperature sensing element to only have very little vibration displacement or even no vibration displacement relative to the housing 1, this makes the connection portions of the pins of the temperature sensing element not receive too much force to cause breaking off or splitting, so that a function failure of the sensor due to mechanical vibration or external mechanical shock is prevented, and the reliability of the temperature sensing element and the sensor is ensured.

As the temperature sensing element has a small volume and a light mass, during installation by welding, the temperature sensing element may deviate towards one lateral side of the housing 1 or even come into contact with the inner wall of the housing 1. The recessed region 32 can guide the temperature sensing element during installation of the first cylinder 3 and correct any offset angle of the temperature sensing element, thereby holding the temperature sensing element in a central position in a radial direction of the housing 1, so that the temperature sensing element is prevented from strong impact with the inner wall of the housing 1 during operation due to offset shifting which would ultimately cause splitting of the pins of the temperature sensing element.

The housing 1 and the first cylinder 3 are both made of heat conductive material. The first cylinder 3 and the filling magnesium oxide powder cooperate to conduct heat together, with a higher heat conducting efficiency in comparison with a structure that is only filled with the particle filler and does not have the first cylinder 3, so that the temperature-detecting response time of the sensor is shortened and the temperature detecting can be performed more quickly and accurately.

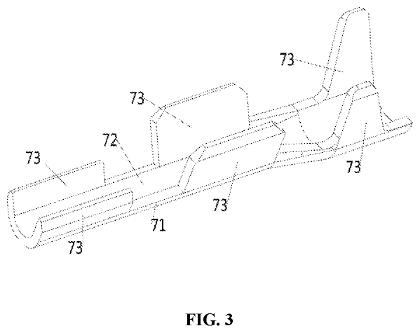

As shown in FIG. 1 and FIG. 3, the connector 7 is preferably made of metal material, and comprises a curved part 71 and foldable edges 73. The curved part 71 has a semi-open curved cavity 72; two lateral parts of the curved part 71 extend outward to form pairs of foldable edges 73, for example, three pairs of foldable edges 73 are formed on the curved part 71 and respectively located at both ends of and a middle part of the curved part 71.

As shown in FIG. 1, the wiring harness component comprises an electric line 62, a second cylinder 61, a third cylinder 63 and a sealing element 64, wherein there are preferably two electric lines 62 corresponding to the two conductive lines 52 of the transmitting cable 5.

An end portion of each electric line 62 is provided in one end of the curved cavity 72, and after the electric line 62 is put into the curved cavity 72, two pairs of foldable edges 73 near the end portion of the electric line 62 are folded into close contact with an outer surface of the electric line 62, so that the end portion of the electric line 62 is riveted and fixed in the curved cavity 72 by wrapping of the two pairs of foldable edges 73; an end portion of each of the two conductive lines 52 of the transmitting cable 5 is provided in the other end of the curved cavity 72, and after the conductive line 52 is put into the curved cavity 72, one pair of foldable edges 73 near the end portion of the conductive line 52 are folded into close contact with an outer surface of the conductive line 52, so that the end portion of the conductive line 52 is riveted and fixed in the curved cavity 72 by wrapping of the one pair of foldable edges 73; then, the conductive line 52 is connected to the electric line 62 by welding, the welding is preferably laser welding.

The arrangement of the connector 7 makes the welding process more stable, and after completion of the welding, the double fixing of welding plus riveting makes the connection between the conductive line 52 and the electric line 62 more secured, with strong reliability.

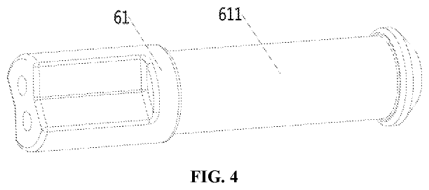

As shown in FIG. 1 and FIG. 4, the second cylinder 61 is preferably made of plastic material and is formed on the two electric lines 62 in a sealedly enwrapping manner by encapsulation plastic injection, and the connection site between the connector 7 and the electric lines 62 is completely wrapped in one end of the second cylinder 61 close to the transmitting cable 5, the other end of the second cylinder 61 away from the transmitting cable 5 is formed with an annular groove 311 recessed inward and situated around a circumferential direction of the second cylinder 61, the two electric lines 62 both have one end sealedly passing through one axial side wall of the second cylinder 61 and connected to the transmitting cable 5, and have the other end sealedly passing through the other axial side wall of the second cylinder 61 and connected to an external control circuit.

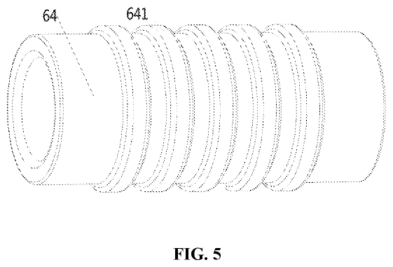

As shown in FIG. 1 and FIG. 5, the sealing element 64 is preferably a cylinder structure made of elastic sealing material, and has an annular protrusion 641 provided on its circumferential outer wall, for example, a plurality of annular protrusions 641 are evenly distributed in an axial direction of the sealing element 64; the sealing element 64 is nested in the annular groove 611.

As shown in FIG. 1, the third cylinder 63 is preferably made of metal material, for example, stainless steel. One end of the third cylinder is a first contraction end 632 sleeved on the metal sheath 51 of the transmitting cable 5, and the other end of the third cylinder extends towards the electric lines 62 and is sleeved on the outer wall of the sealing element 64, completely enclosing the connection portion between the conductive lines 52 and the connector 7 within an inner cavity of the third cylinder; the first contraction end 632 is sealedly connected to the metal sheath 51 by circumference welding, and the other end of the third cylinder is formed with a first annular riveting part 631 recessed in a radially inward direction by circumference riveting, for example, there are five first annular riveting parts 631 each one of which corresponds to one groove between two neighboring annular protrusions 641, and each first annular riveting part 631 is correspondingly closely inserted in a groove between two neighboring annular protrusions 641 to form a sealed fixed connection.

The sealing element 64 is closely compressed between the second cylinder 61 and the third cylinder 63, so as to form a strong and effective sealing and thus prevent external substance such as liquid or gas from entering the third cylinder 63 to cause a function failure of the sensor, thereby rendering high reliability.

The flange 8 is sleeved outside the metal sheath 51 and is fixed to the metal sheath 51 by circumference welding, and the screw nut 9 is slidably sleeved on the metal sheath 51 and is situated between the flange 8 and the third cylinder 63. The flange 8 and the screw nut 9 are structured and sized to adapt to a mounting scene for the customer.

### Embodiment 2

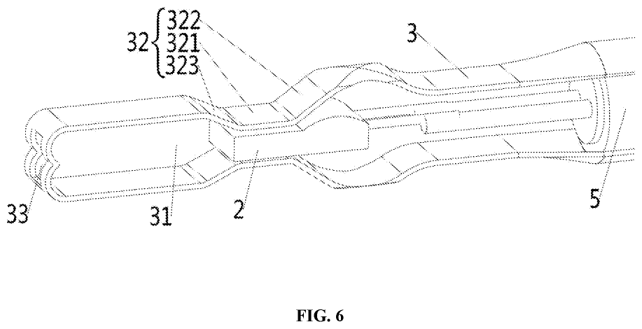

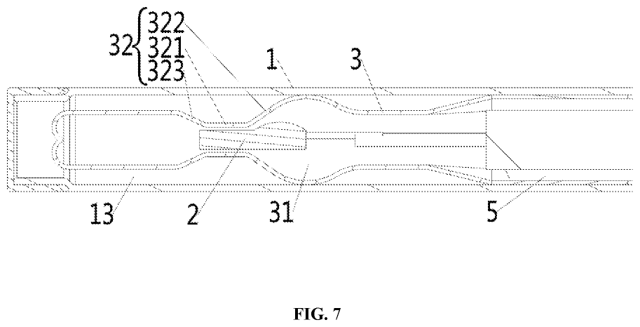

This embodiment provides a sensor, the structure of which differs that of the sensor of Embodiment 1 in that the first cylinder 3 has a different structure, as shown in FIG. 6 and FIG. 7, the first cylinder 3 has a U-shaped symmetrical structure, the hollow part of the U-shaped structure forms a through-hole 31, and the temperature sensing element is inserted in the through-hole 31.

A portion of the first cylinder 3 right facing the temperature sensing element is recessed inward to form a recessed region 32 which has two symmetrical sides, each side of the recessed region 32 comprises a first segment 321, a first flared segment 322 and a second flared segment 323 that are integrally formed in one piece; the first segment 321 is a straight segment extending along an axial direction of the housing 1, the first flared segment 322 and the second flared segment 323 are respectively connected to both ends of the first segment 321 and extend outward at a certain angle away from the temperature sensing element.

The first flared segment 322 is connected to the first cylinder 3 by a curved transition part protruding outward, an outer surface of this curved transition part fits closely on an inner wall of the housing 1, for example, the close fitting is realized by an interference fit; the first segment 321 fits closely on an outer surface of the temperature sensing element, for example, the close fitting is realized by an interference fit. Because the first cylinder 3 is arranged to be fitting closely on both the temperature sensing element and the housing 1, the heat-conducting efficiency of the sensor is increased, and the heat-response time of the sensor is further shortened; meanwhile, the first cylinder 3 has a better fixing effect on the temperature sensing element, thereby further reducing the vibration displacement of the temperature sensing element relative to the housing 1 and further improving the overall reliability of the sensor.

One end of the first cylinder 3 away from the transmitting cable 5 is provided with a buffering hole 33, the buffering hole 33 reduces the rigidity of the first cylinder 3 and makes the first cylinder 3 have better capability of elastic deformation, it is beneficial for dispersing and diverting the impact force received at one point to other parts of the first cylinder 3, so as to have stronger capability of vibration reducing and buffering.

### Embodiment 3

This embodiment provides a sensor, the structure of which differs from that of the sensor of Embodiment 2 in that the recessed region 32 may only comprise a straight first segment 321 and a first flared segment 322 and/or may only comprise a straight first segment 321 and a second flared segment 323.

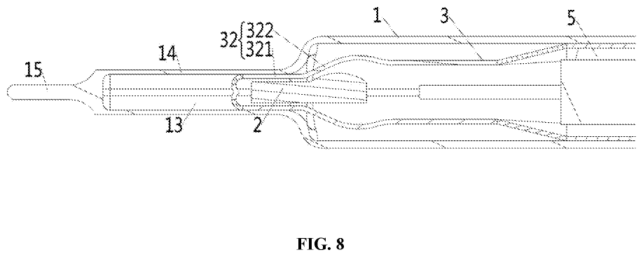

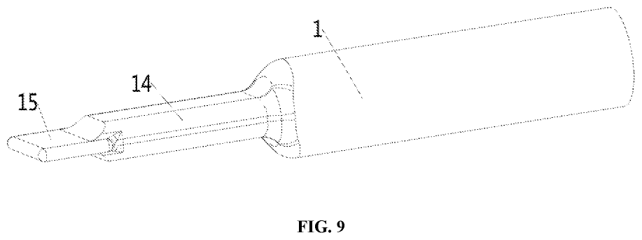

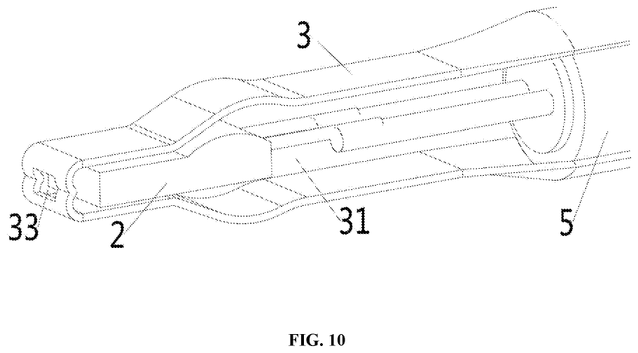

Furthermore, as shown in FIG. 8, FIG. 9 and FIG. 10, herein, the recessed region 32 only comprise a first segment 321 and a first flared segment 322, there is a certain distance from the first flared segment 322 to an inner wall of the housing 1; the first segments 321 at both sides are connected by a curved transition structure, and one end of the first cylinder 3 away from the transmitting cable 5 is likewise provided with a buffering hole 33.

The housing 1 comprises a contraction section 14 and a sealed section 15. The portion of the housing all the way from a location corresponding to the first segment 321 to its end part at an end away from the transmitting cable 5 forms the contraction section 14 recessed inward, the contraction section 14 may be machined by external compression force, an inner wall of the contraction section 14 fits closely on the first segment 321, for example, with a tolerance gap or a buffering gap reserved, so that the first cylinder 3 has a better fixing effect on the temperature sensing element, so that the vibration displacement of the temperature sensing element relative to the housing 1 can be reduced, and the reliability of the sensor is improved.

Meanwhile, the contraction section 14 reduces the straight-line distance between the housing 1 and the temperature-sensing area of the temperature sensing element, so that the heat-response time of the sensor can be shortened.

One end of the contraction section 14 away from the transmitting cable 5 is machined to form a flat sealed section 15, the sealed section 15 seals the housing 1 to form the sealing chamber 13. For example, the sealing is formed by firstly compressing and then welding.

### Embodiment 4

This embodiment provides a sensor, the structure of which differs from that of the sensor provided of any of Embodiments 1-3 in that the number of the first annular riveting part(s) 631 on the third cylinder 63 may be one, two, etc.

As a further alternative embodiment, the third cylinder 63 may not be provided with any first annular riveting part 631, and the sealed connection is only formed by an interference fit between the third cylinder 63 and the sealing element 64; furthermore, the sealing element 64 may not be provided with any annular protrusion 641.

### Embodiment 5

This embodiment provides a sensor, the structure of which differs from that of the sensor of any of Embodiments 1-4 in that the first cylinder 3 may be made of non-elastic material, and the recessed region 32 is made to have a certain capability of elastic deformation by forming through-holes 31 in the recessed region 32.

### Embodiment 6

This embodiment provides a sensor, the structure of which differs from that of the sensor of Embodiments 1-5 in that the detecting element may be a pressure sensing element, a photo-electric sensing element or other types of sending element, herein, the first cylinder 3 and the housing 1 may be made of non-heat-conductive material.

### Embodiment 7

This embodiment provides a sensor, the structure of which differs from that of the sensor of any of Embodiments 1-6 in that the particle filler may be aluminum oxide, boron nitride or other materials having similar physicochemical property; furthermore, there may be no particle filler provided.

### Embodiment 8

This embodiment provides a sensor, the structure of which differs from that of the sensor of any of Embodiments 17 in that the structure of the sealing element in the wiring harness component and the connection means of the second cylinder 61 and the third cylinder 63 are different, while other structures thereof are the same and can refer to the corresponding structures provided by any of Embodiments 1-7.

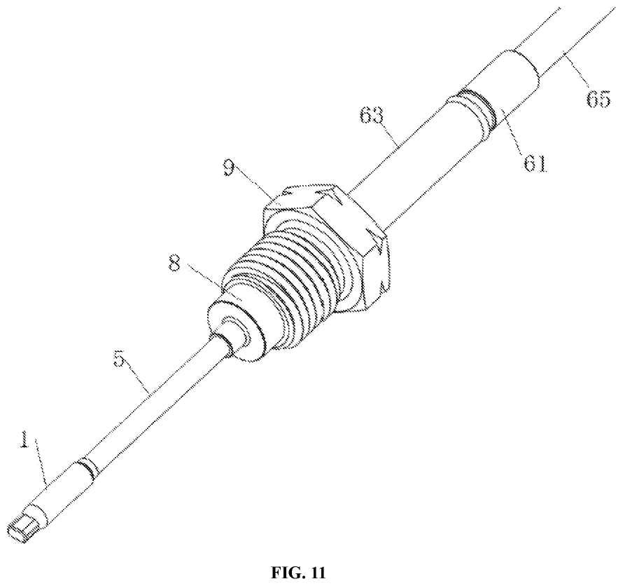

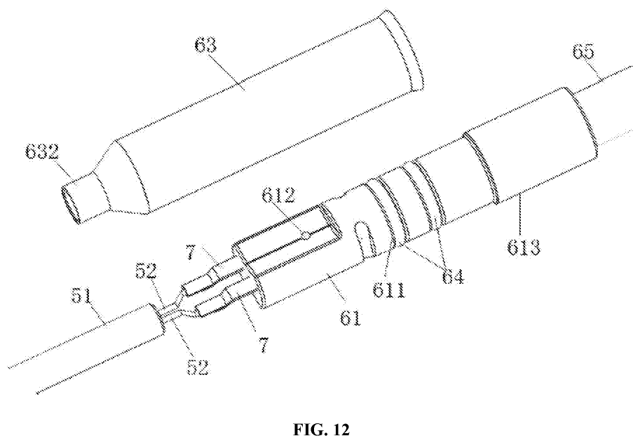

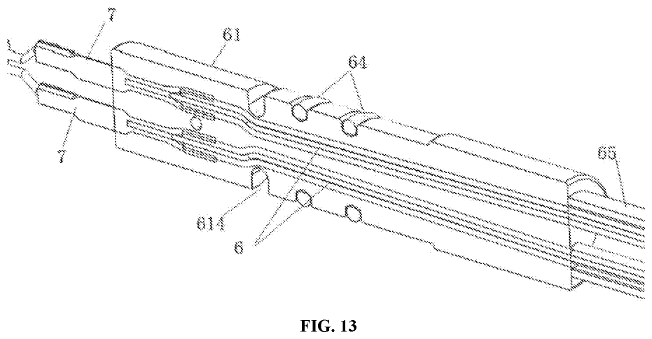

As shown in FIG. 11 and FIG. 12, the wiring harness component also comprises an electric line 62, a second cylinder 61, a third cylinder 63 and a sealing element 64. As shown in FIG. 12 and FIG. 13, the transmitting cable 5 is also connected to the electric line 62 by using a connector 7; the second cylinder 61 may be directly injection-molded on one end of the electric line and one end of the connector 7, in the same way as the injection-molding of the second cylinder in Embodiment 1, referring to Embodiment 1. But if the second cylinder 61 is not formed by injection-molding, the second cylinder 61 is provided with mounting channels therein, each connector 7 and electric line 62 corresponds to one mounting channel, one end of the connector 7 is fixed in the mounting channel, the other end of the connector 7 extends out of the second cylinder 61 towards the transmitting cable 5; one end of the transmitting cable 5 facing the electric line is fixed on the part of the connector 7 extending out of the second cylinder 61, one end of the electric line 62 extends sealedly into the mounting channel of the second cylinder 61 and is fixed on the part of the connector 7 embedded within the mounting channel.

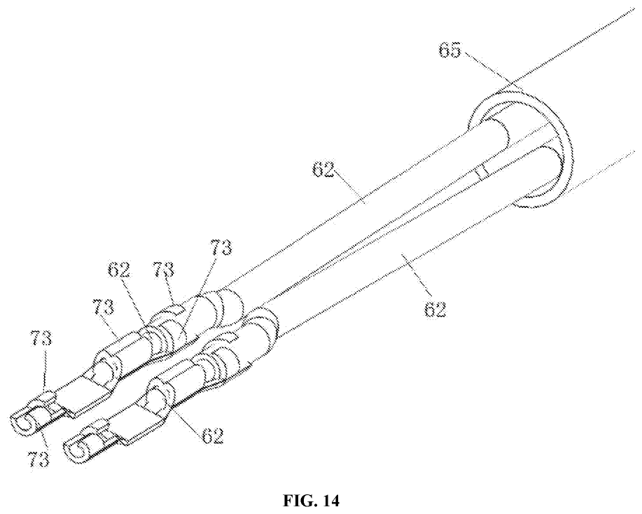

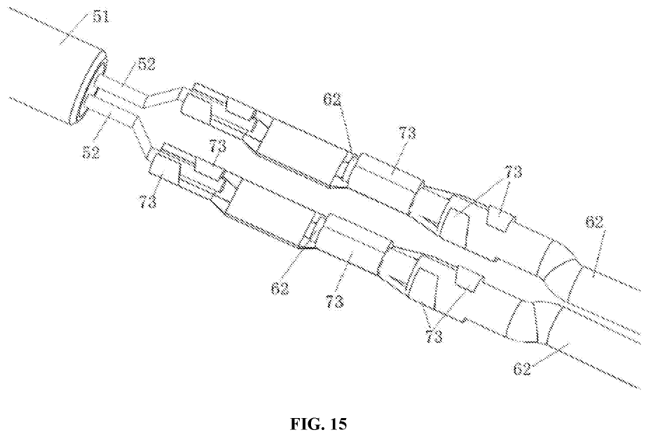

As shown in FIG. 14 and FIG. 15, the only difference of the connector 7 in this embodiment as compared to the connector 7 in Embodiment 1 is that, among the three pairs of foldable edges 73, each pair of the two pairs of foldable edges 73 at both ends of the curved part 71 has interlaced opposing two foldable edges 73, and after these foldable edges are riveted, a fixing area between the foldable edges 73 and the transmitting cable 5 or electric line 62 fixed by them are enlarged, so the connector 7 is firmly connected to the corresponding transmitting cable 5 or electric line 62; and the pair of foldable edges 73 at the middle part of the curved part 71 has two foldable edges 73 opposing each other and having their end parts adjacent to each other connected together to form an enclosed annular cavity, so as to circumferentially fix the end of the electric line 62. Furthermore, As shown in FIG. 15, the portion of the curved part 71 between the pair of foldable edges 73 on the left and the pair of foldable edges 73 in the middle may be a straight flat plate without recessed curved cavity.

As shown in FIG. 13, there are multiple annular grooves 611 provided on an outer wall of the second cylinder 61, such as two, three, four, five, etc. annular grooves, the sealing element 64 are sealing rings correspondingly nested in the annular grooves 611; the third cylinder 63 is closely sleeved on the second cylinder 61, for example, by an interference fit between the third cylinder 63 and the second cylinder 61, so that an inner wall of the third cylinder 63 is closely pressed on the sealing rings, which makes the sealing rings seal the clearance between third cylinder 63 and the second cylinder 61 and isolate it from external environment, thereby prevent gas or liquid solution of external environment from entering the inner cavity of the third cylinder to affect the detecting performance of the sensor. As for the sealing rings, a larger number of the sealing rings leads to better sealing property for the clearance between the third cylinder 63 and the second cylinder 61, and the specific arranged number may be determined according to actual needs. Of course, there may be only one annular groove 611, and correspondingly there is only one sealing ring.

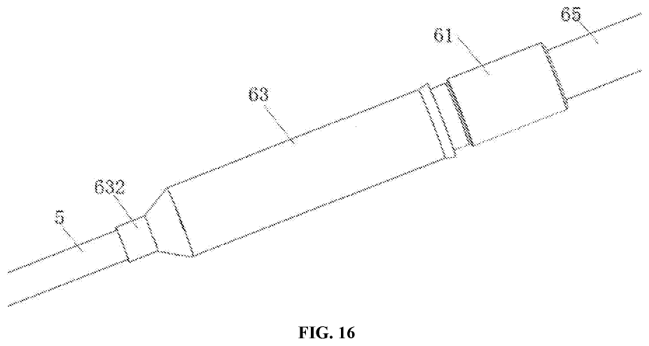

As shown in FIG. 12 and FIG. 16, one end of the second cylinder 61 away from the first contraction end 632 on the third cylinder serves as an outer extension end 613, the first contraction end 632 is sealedly sleeved on an outer wall of the transmitting cable 5; the outer extension end 613 extends out of the third cylinder 63 and is sealedly sleeved on the electric line 62, which lengthens the sealing portion between the second cylinder 61 and the electric line 62 and further ensures the firmness of the sealed connection between the electric line 62 and the second cylinder 61. An annular step is formed between the outer extension end 613 and the part of the second cylinder 61 provided with the annular grooves 611, for example, the part of the third cylinder 63 corresponding to the sealing rings is riveted to induce an interference fit between the third cylinder 63 and the second cylinder 61 so as to form the afore-mentioned annular step. The other end of the third cylinder 63 away from the first contraction end 632 is a flared end facing the stepped surface of the annular step, the stepped surface has a limiting effect on the position of the third cylinder 63.

As shown in FIG. 12, the second cylinder 61 is also provided with an open hole 612, the arrangement of the open hole 612 separates the two terminals of the two electric lines 62 and prevents the terminals of the two electric lines 62 from short-circuiting, so that the reliability of the electric lines 62 is ensured. Meanwhile, as the second cylinder 61 is injection-molded on the electric lines 62, the open hole 612 can also serve as a locating hole for the injection-molding. Furthermore, as shown in FIG. 13, when the second cylinder 61 is injection-molded in place on the electric lines 62, two opposing curved grooves 614 are injection-molded on an outer wall of the second cylinder 61, each of the two curved grooves 614 corresponds to one electric line 62, this makes a near distance between the two electric lines 62 and respectively has a guiding and positioning effect on the orientation of the two electric lines 62. If the second cylinder is made of plastic material and is formed on the two electric lines 62 in a sealedly enwrapping manner by encapsulation plastic injection, the two curved grooves 614 can also prevent an outer wall of the electric line 62 from being exposed to the outside.

As shown in FIG. 12 and FIG. 14, a protective sleeve 65 is also sleeved on an outer wall of the electric line 62 between the second cylinder 61 and the module having the control circuit (not shown in the drawings), for example, a woven mesh tube formed by heat-resisting material, the two ends of the protective sleeve 65 respectively abut against an axial end face of the second cylinder 61 and against an axial end face of the module having the control circuit, so as to have a protective effect on the electric line 62. Wherein, the heat-resisting material may be PPS plastics, polyimide plastics, polytetrafluoroethylene plastics or other heat-resisting materials, thereby making the sensor of the present application be a sensor usable in a high temperature environment.

### Embodiment 9

This embodiment provides a sensor, the structure of which differs from that of the sensor of any of Embodiments 1-8 in that the structure of the sealing element in the wiring harness component and the connection means of the second cylinder 61 and the third cylinder 63 are different, while other structures thereof are the same and can refer to the corresponding structures provided by any of Embodiments 1-8.

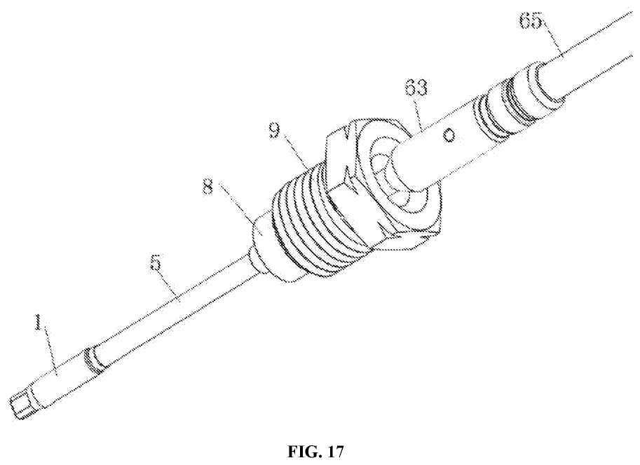

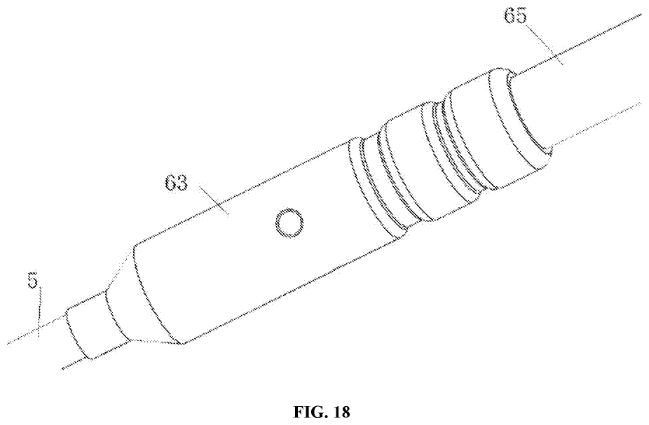

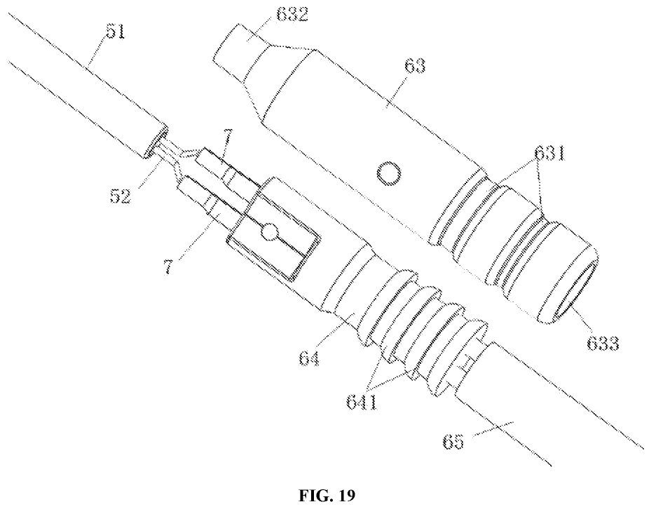

As shown in FIG. 17, FIG. 18 and FIG. 19, the afore-mentioned annular groove 611 is not provided on the outer wall of the second cylinder 61; the sealing element is a sealing plug, one end face of the sealing plug facing the second cylinder 61 abuts against an end face of the second cylinder 61. The third cylinder 63 is sleeved on outer walls of the second cylinder 61 and the sealing plug, the first contraction end 632 of the third cylinder 63 is sealedly sleeved on the metal sheath of the transmitting cable 5, the other end of the third cylinder 63 opposite to the first contraction end is closely sleeved on the electric line 62 and is a second contraction end 633 contracting in a radially inward direction, for example, the second contraction end 633 is formed by radially riveting, so the sealing plug and the second cylinder 61 are both accommodated within an inner cavity of the third cylinder 63, wherein the two ends of the sealing plug respectively abut against an end face of the second cylinder 61 facing the sealing plug and against an inner wall of the second contraction end, thereby realizing the axial positioning of the sealing plug.

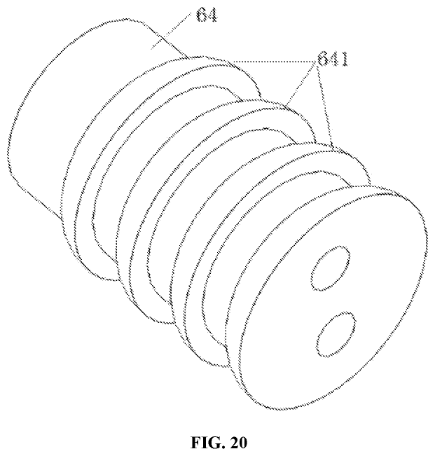

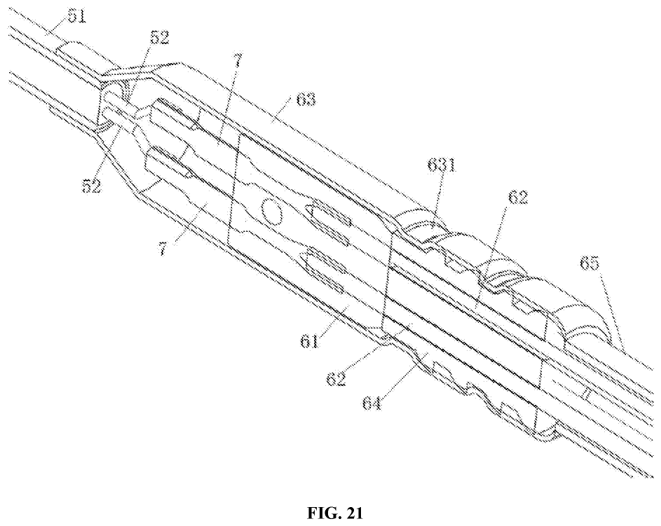

As shown in FIG. 20 and FIG. 21, multiple annular protrusions are provided on an circumferential outer wall of the sealing plug, for example, the annular protrusions have an annular bowl-like shape, the wall of the third cylinder 63 has first annular riveting parts 631 recessed inward; each first annular riveting parts 631 is closely inserted in a groove between two neighboring annular protrusions, but the first annular riveting parts 631 may not correspond one by one to the grooves formed between every two neighboring annular protrusions, for example, there are three grooves and two first annular riveting parts 631, and the two first annular riveting parts 631 may be respectively inserted in the grooves on both end sides, while no first annular riveting part 631 is riveted in the one groove in the middle; an interference fit is adopted between the third cylinder 63 and the second cylinder 61 as well as between the third cylinder 63 and the sealing plug, so that the sealing plug is compressed and deformed to further strengthen the sealed connection between the third cylinder 63 and the sealing plug as well as between the sealing plug and the electric line 62, the inner cavity of the third cylinder 63 is sealed and isolated from external environment, thereby preventing external gas or liquid from entering the inner cavity of the third cylinder 63 to cause a detecting function failure of the sensor.

Similar to Embodiment 8, a protective sleeve 65 is sleeved on the electric line 62 between the third cylinder 63 and the module having the control circuit, which has a protective effect on the electric line 62, herein, an outer end face of the second contraction end of the third cylinder 63 abuts against an end face of the protective sleeve 65. Furthermore, the sealing elements in Embodiment 1, Embodiment 8 and Embodiment 9 can be interchanged. Sealing by a sealing plug forms continuous seal, and sealing by a sealing ring belongs to interval seal.

### Embodiment 10

This embodiment provides a sensor, the structure of which differs from that of the sensor of any of Embodiments 1-9 in that the structure of the housing 1 is different, while other structures thereof are the same and can refer to the corresponding structures provided by any of Embodiments 1-9, which are not redundantly described herein.

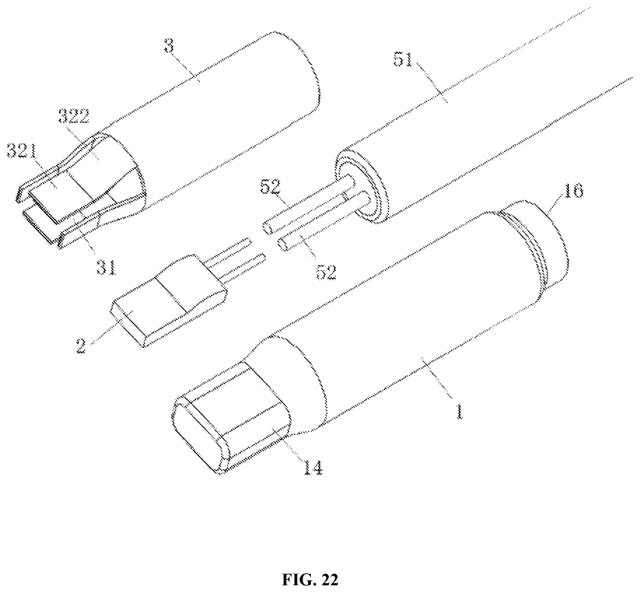

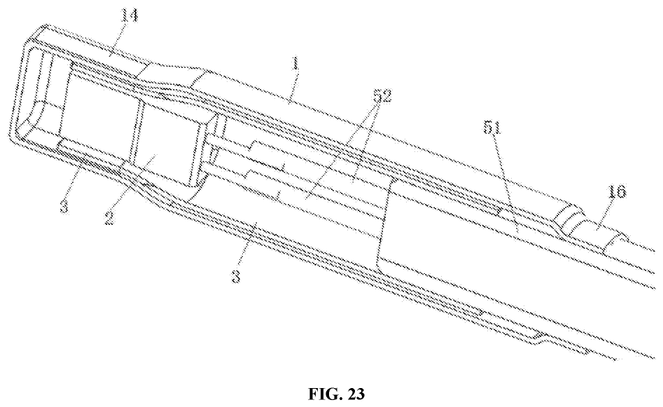

With respect to the housing 1, as shown in FIG. 22 and FIG. 23, in this embodiment, the housing 1 is not provided with the cap mentioned in Embodiment 1, and the structure of the housing is similar to the housing 1 provided in Embodiment 3, both ends of the housing 1 are contraction segments, respectively including a first contraction segment shielding one end of the first cylinder away from the transmitting cable 5 and the detecting element, and a second contraction segment sealedly sleeved on an outer wall of the transmitting cable 5. The end part of the first contraction segment is in the form of a closed end, and the end part of the second contraction segment is in the form of a first contraction opening 16, a gap is preserved between an inner wall of the closed end of the first contraction segment and the detecting element 2, the inner wall of the first contraction segment is fitting closely on an outer wall of the first cylinder, especially when the detecting element is a temperature sensing element, the gap between the inner wall of the first contraction segment and the temperature sensing element is shortened, and the volume of the heat-conducting medium is reduced, which means the straight-line distance from the first contraction segment to the temperature sensing area of the detecting element is shortened, so that the response time of the sensor is shortened, and the sensitivity of the sensor is increased. Meanwhile, the arrangement of the first contraction opening 16 makes the housing 1 in close contact with the transmitting cable 5 for fixing by welding.

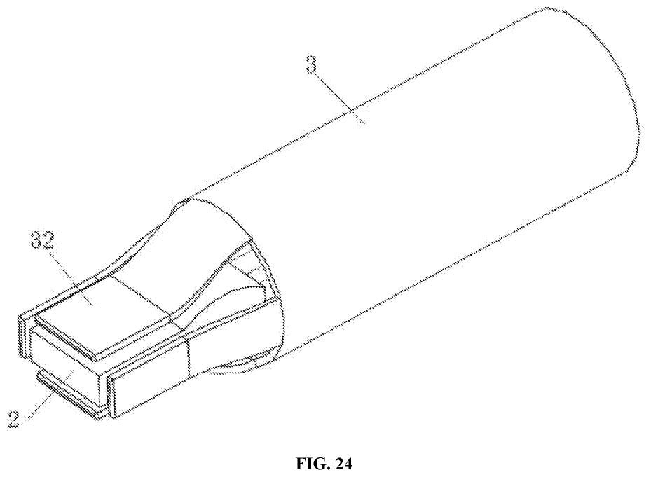

Furthermore, as an alternative embodiment of any of the above embodiments, as shown in FIG. 22 and FIG. 24, the difference of the structure of the first cylinder 3 in this embodiment as compared to the structure of the first cylinder 3 in Embodiment 1 is that the first cylinder 3 only comprises a first segment 321 and a first flared segment 322, and the through-hole 31 has a notch shape, an open end of the notch is situated away from the first flared segment 322, thereby simplifying the processing and manufacturing of the first cylinder 3 and reducing the cost. In this embodiment, the inner wall of the first segment 321 is likewise adjacent to and fitting closely on an outer wall of the detecting element 2, so that the first segment 321 has a limiting effect on the position of the detecting element 2 and has a vibration reducing effect on the detecting element 2.

For example, there are four through-holes 31 extending along the axial direction of the first cylinder 3, and the four through-holes 31 are evenly distributed around a circumferential direction of the recessed region 32 to divide the recessed region 32 into four elastic protective plates, the four elastic protective plates have a protective effect for the detecting element 2 in four directions and have a position-limiting effect as well as a vibration reducing effect on the detecting element 2. Of course, the number of the through-holes 31 may also be one, two, three, five, six, etc. The specific arranged number may be set according to actual needs.

Apparently, the aforementioned embodiments are merely examples illustrated for giving a clear description, rather than limiting the implementation ways thereof. For a person with ordinary skill in the art, various changes and modifications in other different forms can be made on the basis of the aforementioned description. It is unnecessary and impossible to exhaustively list all the implementation ways herein. However, any obvious changes or modifications derived from the aforementioned description are intended to be embraced within the protection scope of the present application.

1-23. (canceled)

24. A sensor, comprising
a housing;
a detecting element, provided inside the housing;
a first cylinder, provided inside the housing and sleeved outside the detecting element, the first cylinder having an amount of elastic deformation in a direction intersecting a surface around the detecting element;
a particle filler, for filling an inner cavity of the housing.

25. The sensor according to claim 24, wherein, the first cylinder has at least one through-hole provided thereon.

26. The sensor according to claim 25, wherein, the first cylinder has a recessed region in a radially inward direction; the recessed region is sleeved on the detecting element, and the through-hole is formed in the recessed region.

27. The sensor according to claim 26, wherein, the recessed region comprises, along an axial direction of the first cylinder, a straight first segment and a first flared segment flaring outward from one open end of the first segment, the first segment fitting closely on the detecting element.

28. The sensor according to claim 27, wherein, the recessed region also comprises a second flared segment flaring outward from the other open end of the first segment, so that the recessed region has a crown spring structure.

29. The sensor according to claim 27, wherein, the recessed region also comprises a second flared segment flaring outward from the other open end of the first segment; the first flared segment has a curved structure protruding outward, with an outer wall of the curved structure fitting closely on an inner wall of the housing.

30. The sensor according to claim 25, wherein, at least two through-holes are provided, each of the through-holes is arranged to extend in an axial direction of the first cylinder, and all the through-holes are distributed in a circumferential direction of the recessed region.

31. The sensor according to claim 27, wherein, a portion of the housing corresponding to the first segment is a contraction section, with an inner wall of the contraction section fitting closely on an outer wall of the first segment.

32. The sensor according to claim 24, wherein, the sensor also comprises a transmitting cable and a wiring harness component; one end of the transmitting cable is arranged to extend sealedly into the housing and be connected to the detecting element, the other end of the transmitting cable is connected to the wiring harness component; the wiring harness component is connected to an external control circuit, for transmitting signal detected by the detecting element via the transmitting cable to the control circuit.

33. The sensor according to claim 32, wherein, one end of the housing away from the detecting element is sealedly sleeved on the transmitting cable, and the other end of the housing is arranged to sealedly enclose the detecting element and the first cylinder.

34. The sensor according to claim 33, wherein, the end of the housing sleeved on the transmitting cable has a first contraction opening, and the other end of the housing opposite to the first contraction opening has a contraction segment, the end part of the contraction segment is in the form of a closed end, with a gap preserved between an inner wall of the closed end and the detecting element.

35. The sensor according to claim 32, wherein, the wiring harness component comprises
a second cylinder;
an electric line, one end of the electric line is arranged to sealedly pass through one axial side wall of the second cylinder and be connected to the control circuit, and the other end of the electric line is arranged to sealedly pass through the other axial side wall of the second cylinder and be connected to the transmitting cable;
a third cylinder, one end of which is sealedly sleeved, through an elastic sealing element, on the second cylinder or on a portion of the electric line outside the second cylinder, the other end of which is arranged to extend in a direction towards the transmitting cable and be sealedly fixed on an outer wall of the transmitting cable, so as to enclose a connection end of the transmitting cable connecting to the electric line inside the third cylinder.

36. The sensor according to claim 35, wherein, an annular groove is provided on a circumferential outer wall of the second cylinder; the sealing element is nested in the annular groove, and the third cylinder is closely pressed on an outer wall of the sealing element.

37. The sensor according to claim 36, wherein, the outer wall of the sealing element has at least one annular protrusion, and the third cylinder is closely pressed on the annular protrusion.

38. The sensor according to claim 37, wherein, a wall of the third cylinder has a first annular riveting part recessed inward; the first annular riveting part is closely inserted in a groove between two neighboring annular protrusions.

39. The sensor according to claim 36, wherein, at least one annular groove is provided, the sealing element is a sealing ring, and the sealing ring is correspondingly nested in the annular groove.

40. The sensor according to claim 36, wherein, one end of the second cylinder away from the transmitting cable is arranged to extend out of the third cylinder and be sealedly sleeved on the electric line.

41. The sensor according to claim 35, wherein, when one end of the third cylinder is sealedly sleeved, through the elastic sealing element, on a portion of the electric line outside the second cylinder, the sealing element is sealedly sleeved on the electric line, with one end thereof facing the second cylinder abuts against an end face of the second cylinder; one end of the third cylinder away from the transmitting cable is closely sleeved on the sealing element.

42. The sensor according to claim 41, wherein, the end of the third cylinder away from the transmitting cable has a second contraction end contracted radially inward; both ends of the sealing element abut, respectively, against an end face of the second cylinder and against an inner wall of the second contraction end, so as to accommodate the sealing element and the second cylinder in an inner cavity of the third cylinder.

43. The sensor according to claim 42, wherein, a circumferential outer wall of the sealing element has at least one annular protrusion, a wall of the third cylinder has a first annular riveting part recessed inward; the first annular riveting part is closely inserted in a groove between two neighboring annular protrusions.
